(19) United States
(12) Patent Application Publication
(10) Pub. No.: US 2024/0163208 A1
(43) Pub. Date: May 16, 2024

(54) PACKET PROCESSING METHOD AND APPARATUS, AND STORAGE MEDIUM AND ELECTRONIC APPARATUS

(71) Applicant: ZTE Corporation, Shenzhen (CN)

(72) Inventors: Zheng ZHANG, Shenzhen (CN); Yong CHEN, Shenzhen (CN); Benchong XU, Shenzhen (CN)

(21) Appl. No.: 18/282,592

(22) PCT Filed: Feb. 10, 2022
(86) PCT No.: PCT/CN2022/075883

§ 371 Date: Sep. 18, 2023

(30) Foreign Application Priority Data
Apr. 21, 2021 (CN) 202110432551.5

(51) Int. Cl. H04L 45/00; H04L 45/74; H04L 69/22

(52) U.S. Cl. CPC H04L 45/566; H04L 45/74; H04L 69/22

(57) ABSTRACT

Provided are a packet processing method and apparatus, and a storage medium and an electronic apparatus. The method includes: receiving a target packet from an ingress node; determining a type of a payload contained in the target packet and a start location of the payload; performing a payload parsing operation on the target packet based on the type of the payload and the start location of the payload to obtain payload data of the payload; and forwarding the payload data to a receiving end.

### CROSS-REFERENCE TO RELATED APPLICATION

The disclosure is based upon and claims priority to Chinese Patent Application CN202110432551.5 filed to the China National Intellectual Property Administration on Apr. 21, 2021 and entitled “Packet Processing Method and Apparatus, Storage Medium and Electronic Apparatus”, the disclosure of which is hereby incorporated by reference in its entirety.

### TECHNICAL FIELD

Embodiments of the present disclosure relate to the field of communications, and in particular, to a packet processing method and apparatus, a storage medium and an electronic apparatus.

### BACKGROUND

BIER (Bit Indexed Explicit Replication) (RFC8279) is a novel multicast data forwarding technology. By using this technology, a node at a network edge is represented by using one bit, multicast traffic is transmitted in an intermediate network, and a specific BIER header is additionally encapsulated. In the packet header, all destination nodes Bit-Forwarding Egress Routers (BFERs) of a multicast stream is labeled in a form of a bit string. An intermediate network forwarding node performs routing according to the bit, so as to ensure that the traffic can be transmitted to all destination nodes.

Multicast technology refers to that a source host only transmits one copy of data, and a data destination address is a multicast group address, so that all member devices belonging to the group can receive a copy of data transmitted by the source host. The ingress node Bit-Forwarding Ingress Router (BFIR) in the BIER domain encapsulates the multicast traffic entering the BIER domain as a payload of the BIER header. Through the forwarding of an intermediate node, the egress node BFER in the BIER domain receives a BIER packet. The payload is forwarded to a corresponding receiver after removing the BIER header.

In a normal case, all nodes in the BIER domain can encapsulate and perform forwarding processing on the BIER packet, or in a case that all devices in a network can be upgraded to support a complete BIER technology, the BIER technology may also be deployed smoothly.

However, the devices in the actual network cannot be upgraded at the same time, particularly, there are a large number of egress nodes connecting the receiver and great performance differences, and some egress nodes have high performance, a complete BIER technology can be upgraded and supported very easily. However, for some egress devices with poor performance, it is very difficult to upgrade and support the complete BIER technology, which greatly affects a normal operation of the BIER.

### SUMMARY

Embodiments of the present disclosure provide a packet processing method and apparatus to at least solve the problem in a related art that a packet cannot be forwarded normally in a case that a network node cannot support a complete BIER technology.

According to an embodiment of the present disclosure, a packet processing method is provided, which includes the following operations.

A target packet from an ingress node is received.

A type of a payload contained in the target packet and a start location of the payload are determined.

A payload parsing operation is performed on the target packet based on the type of the payload and the start location of the payload to obtain payload data of the payload.

The payload data is forwarded to a receiving end.

In an exemplary embodiment, the operation that the type of the payload contained in the target packet and the start location of the payload are determined includes the following operations.

A start location of the target packet is determined based on the type of the target packet.

The type of the payload and the start location of the payload are determined based on the start location of the target packet.

In an exemplary embodiment, the operation that the start location of the payload is determined based on the start location includes the following operations.

In a case that the target packet is determined as a first type packet, a packet header of the target packet is skipped to determine the start location of the payload.

In a case that the target packet is determined as other types of packets other than the first type packet, a first information value of the target packet is acquired. The first information value is used for indicating a length of first information. The start location of the payload is determined based on the first information value.

In an exemplary embodiment, the operation that the type of the payload is determined based on the start location of the target packet includes the following operations.

In a case that the target packet is determined as the first type packet, a target header field contained in the target packet is determined based on the start location of the target packet, and the type of the payload is determined based on the target header field.

In a case that the target packet is determined as other types of packets other than the first type packet, a second offset calculation is performed on the target packet based on the start location of the target packet to obtain an attribute value of the target packet, and the type of the payload is determined based on the attribute value.

In an exemplary embodiment, after receiving the target packet from the ingress node, the method further includes: in a case that the target packet is determined as the first type packet, a first positioning operation is performed based on an SA contained in the target packet to obtain a first positioning result; and the operation that the payload data is forwarded to the receiving end includes: in a case that a target node is positioned based on the first positioning result, the payload data is transmitted to the target node to indicate the target node to transmit the payload data to the receiving end.

Or,
after receiving the target packet from the ingress node, the method further includes: in a case that the target packet is determined as other types of packets other than the first type packet, the target node is searched according to the type of the payload; and the operation that the payload data is forwarded to the receiving end includes: in a case that the target node is searched, a third offset operation is performed on the payload to obtain target payload data, and the target payload data is transmitted to the target node to indicate the target node to transmit the payload data to the receiving end.

In an exemplary embodiment, before determining the type of the payload contained in the target packet and the start location of the payload, the method further includes the following operations.

In a case that the target packet is determined as the first type packet, whether the ingress node is a first ingress node corresponding to a locally stored first ingress node identifier is determined based on an SA contained in the target packet.

In a case that the target packet is determined as other types of packets other than the first type packet, second information contained in the target packet is acquired, a fourth offset calculation is performed on the target packet based on the second information and the start location of the target packet to determine a node identifier value of the first ingress node, and whether the ingress node is the first ingress node corresponding to the locally stored first ingress node identifier is determined based on the node identifier value and the second information.

The operation that the type of the payload contained in the target packet and the start location of the payload are determined includes: in a case that the ingress node is determined as the first ingress node corresponding to the locally stored first ingress node identifier, the type of the payload contained in the target packet and the start location of the payload are determined.

In an exemplary embodiment, the operation that the first information value of the target packet is acquired includes at least one of the following.

The first information value from the ingress node is received.

The first information value from a controller is received.

A preset first information value is acquired.

In an exemplary embodiment, after performing a payload parsing operation on the target packet based on the type of the payload and the start location of the payload to obtain payload data of the payload, the method further includes the following operations.

In a case that it is determined that there is no receiving end for receiving the payload data, at least one of the following operations is performed.

A first feedback is transmitted to the ingress node. The first feedback is used for indicating to refuse to receive the packet to be transmitted to the receiving end.

A second feedback is transmitted to a controller to indicate the controller to transmit a third feedback to the ingress node. The third feedback is used for indicating to refuse to receive the packet to be transmitted to the receiving end.

In an exemplary embodiment, the method further includes the following operation.

A fourth feedback is transmitted to the ingress node or the controller. The fourth feedback is used for indicating at least one piece of the following information: an egress node being a node not supporting a predetermined technology, and a capability level of the egress node supporting the predetermined technology.

According to another embodiment of the present disclosure, a packet processing apparatus is provided, which includes a receiving module, a determination module, a parsing module, and a transmitting module.

The receiving module is configured to receive a target packet from an ingress node.

The determination module is configured to determine a type of a payload contained in the target packet and a start location of the payload.

The parsing module is configured to perform a payload parsing operation on the target packet based on the type of the payload and the start location of the payload to obtain payload data of the payload.

The transmitting module is configured to forward the payload data to a receiving end.

According to still another embodiment of the present disclosure, a computer-readable storage medium is further provided. The computer-readable storage medium stores a computer program. The computer program is configured to perform the steps in any one of the method embodiments when running.

According to still another embodiment of the present disclosure, an electronic apparatus is further provided. The electronic apparatus includes a memory and a processor. The memory stores a computer program, and the processor is configured to run the computer program to perform the steps in any one of the method embodiments.

### BRIEF DESCRIPTION OF THE DRAWINGS

FIG. 1 is a block diagram of a hardware structure of a mobile terminal of a packet processing method according to an embodiment of the present disclosure.

FIG. 2 is a flowchart of a packet processing method according to an embodiment of the present disclosure.

FIG. 3 is a format diagram 1 of packet header encapsulation according to an embodiment of the present disclosure.

FIG. 4 is a format diagram 2 of packet header encapsulation according to an embodiment of the present disclosure.

FIG. 5 is a format diagram 3 of packet header encapsulation according to an embodiment of the present disclosure.

FIG. 6 is a format diagram 4 of packet header encapsulation according to an embodiment of the present disclosure.

FIG. 7 is a node diagram of a packet processing method according to an embodiment of the present disclosure.

FIG. 8 is a node diagram of a packet processing method according to an embodiment of the present disclosure.

FIG. 9 is a block diagram of a packet processing apparatus according to an embodiment of the present disclosure.

FIG. 10 is a general flowchart of a packet processing method according to a specific embodiment of the present disclosure.

FIG. 11 is a format diagram of a packet header according to a specific embodiment of the present disclosure.

FIG. 12 is a schematic structural diagram of a Threshold Limit Value (TLV) according to a specific embodiment of the present disclosure.

FIG. 13 is a flowchart of a specific embodiment 1 of the present disclosure.

FIG. 14 is a node diagram of a specific embodiment 2 of the present disclosure.

### DETAILED DESCRIPTION OF THE EMBODIMENTS

Embodiments of the present disclosure are described in detail below with reference to the drawings and in conjunction with the embodiments.

It is to be noted that the specification and claims of the present disclosure and the terms “first”, “second” and the like in the drawings are used to distinguish similar objects, and do not need to describe a specific sequence or a precedence order.

As shown in FIG. 8, it is assumed that there are many network egress nodes in a BIER network, from BFER1, BFER2 to BFERn.

It is assumed that BFER1 and BFER2 cannot support a complete BIER technology, then BFER1/BFER2 are upgraded at a software level according to draft-ietf-bier-php, but a hardware level is not upgraded.

For a last hop device BFRm of the BFER1 and the BFER2, special cases of the BFER1 and the BFER2 and a special encapsulation manner transmitted to the BFER1/BFER2 need to be recorded. When a BIER packet is received and needs to be forwarded to the BIER1 and the BIER2, the BFRm needs to remove a BIER header before copying and forwarding a normal BIER packet to other nodes (for example, possible BFER3/BFER4 or BFERn), encapsulates the payload in a tunnel manner notified by the BFER1/BFER2, and then transmits the payload to the BFER1/BFER2 node.

Subsequently, after the tunnel encapsulation is removed from the BFER1/BFER2, and a corresponding receiver is found and the BFER1/BFER2 is forwarded.

In this process, since part egress nodes BFERs cannot completely support the BIER technology, an upstream device, that is, the foregoing last-hop device BFRm has to notify according to protocols, such as OSPF/ISIS of the BFER1/BFER2, and a state that the BFRm does not support the BIER technology is recorded, a tunnel encapsulation form required by the BFRm is recorded, and such BFER node is encapsulated separately when the BIER packet is forwarded.

Therefore, in a case that there are many BFER nodes that do not support the complete BIER technology, the technology has very high technical and performance requirements on an upstream node of the BFER, that is, the last-hop node, and has a great impact on a processing process and a forwarding process thereof, so this is not the most optimal solution for the scenario.

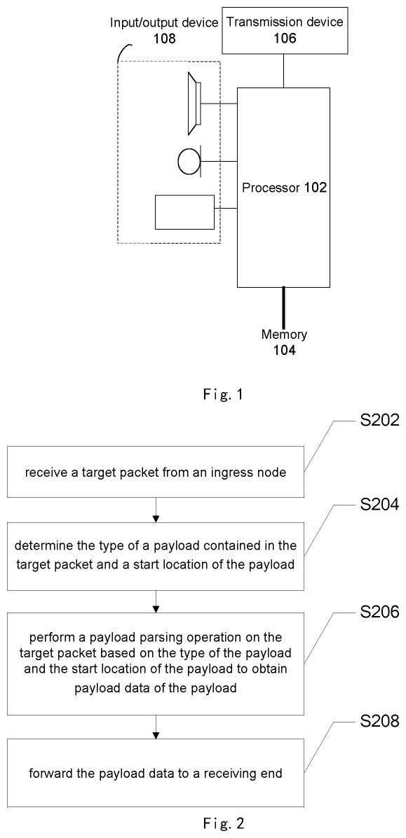

The method embodiment provided in the embodiments of the present application may be executed in a mobile terminal, a computer terminal or a similar computing apparatus. Taking running in the mobile terminal as an example, FIG. 1 is a block diagram of a hardware structure of a mobile terminal of a packet processing method according to the embodiment of the present disclosure. As shown in FIG. 1, the mobile terminal may include one or more (only one shown in FIG. 1) processors 102 (the processors 102 include, but are not limited to, processing apparatuses of a Micro Processing Unit (MCU), a Field Programmable Gate Array (FPGA), or the like) and a memory 104 configured to store data. The above mobile terminal may further include a transmission device 106 and an input/output device 108 configured to have a communication function. Those of ordinary skill in the art may understand that the structure shown in FIG. 1 is only illustrative and does not limit the structure of the mobile terminal. For example, the mobile terminal may also include more or fewer components than those shown in FIG. 1, or has a different configuration from that shown in FIG. 1.

The memory 104 may be configured to store a computer program, for example, a software program of application software and modules, such as a computer program corresponding to a packet processing method in the embodiments of the present disclosure. The processor 102 executes various functional applications and data processing, that is, implements the method by running the computer program stored in the memory 104. The memory 104 may include a high speed random access memory or a non-volatile memory such as one or more magnetic storage apparatuses, flash memories, or other non-volatile solid state memories. In some embodiments, the memory 104 may further include memories remotely located relative to the processor 102. These remote memories may be connected to the mobile terminal through a network. The examples of the network include, but are not limited to, the Internet, the Intranet, a local area network, a mobile communication network, and combinations thereof.

The transmission device 106 is configured to receive or transmit data through a network. Specific instances of the network may include a wireless network provided by a communication provider of the mobile terminal. In one instance, the transmission device 106 includes a Network Interface Controller (NIC) that can be connected to other network devices through a base station to communicate with the Internet. In one instance, the transmission device 106 may be a Radio Frequency (RF for short) module, which is configured to communicate with the Internet in a wireless manner.

A packet forwarding method is provided in the present embodiment. FIG. 2 is a flowchart of a packet forwarding method according to an embodiment of the present disclosure. As shown in FIG. 2, the flow includes the following steps.

At S202, a target packet from an ingress node is received.

In the present embodiment, the target packet may be (but is not limited to) a packet in an IPV6 format, may also be a packet with an Ether type of 0xAB37, or may also be a packet in an MPLS format or a packet in other formats. An ingress node may be a physical data interface, or may be virtual node in a data forwarding process, or may also be other units or modules with a transceiving function.

At S204, a type of a payload contained in the target packet and a start location of the payload are determined.

In the present embodiment, the type of the payload and the start location of the payload may (but not limited to) be determined according to data such as address information contained in the packet header of the target packet, or may also be directly determined according to the start location of the target packet by skipping the packet header of the target packet.

For example, a method for skipping the packet header to obtain the start location of the payload may be that an IPv6 header and a possible extended header are removed to obtain a starting location of the payload of the BIER packet in a case that a type of the target packet is in an IPV6 format. For example, a Destination Options Header (DOH) is removed; or, BitStringLength (BSL) information may be determined according to the start location of the target packet, and the starting location of the payload of the BIER packet is determined according to a length value L in the BSL information.

A manner of acquiring the type of the payload may be that the packet type of the payload is learned according to a Next Header field in an extended header of the DOH of the IPv6 header when the type of the target packet is the IPV6 format and contains a Destination Address (DA), and the BIER header of the target packet is encapsulated in the extended header of the DOH of the IPv6 header. The BIER may also be encapsulated in other extended headers such as a Hop-by-Hop Header (HBH) and an IPv6 Segment Routing Header. A manner for determining the type of the payload is similar.

When the type of the target packet is in the IPV6 format and the contained DA is a local address, 74 bits are offset from the starting location of the BIER header, a 6-bit Proto value is read, and the type of the payload packet is determined according to the value.

At S206, a payload parsing operation is performed on the target packet based on the type of the payload and the start location of the payload to obtain payload data of the payload.

In the present embodiment, the acquired payload data includes (but is not limited to) information such as a forwarding destination node address of the payload, a forwarding time of the payload, a forwarding frequency of the payload, and the like.

At S208, the payload data is forwarded to a receiving end.

In the present embodiment, the payload data may be forwarded simultaneously, in batches, or in other types of forwarding manners. Correspondingly, there may be one or more receiving ends. A plurality of receiving ends may receive the payload data simultaneously, or the plurality of receiving ends may receive the payload data in batches, or one receiving end receives a plurality of batches of payload data simultaneously, or one receiving end receives a plurality of batches of payload data in batches.

Taking the BIER as an example, an ingress node BFIR in the BIER domain encapsulates the multicast traffic entering the BIER domain as a payload of the BIER header. Through the forwarding of the intermediate node, the egress node BFER in the BIER domain receives a BIER packet. The Payload is forwarded to a corresponding receiver after removing the BIER header.

Through the above steps, the payload data may be directly determined based on the type of the payload and the start location of the payload, so as to realize the forwarding of the payload, thereby achieving a purpose of forwarding of the payload data without supporting the complete BIER technology, solving the problem that the target packet cannot be forwarded normally since a network node cannot support the complete BIER technology, and improving the packet forwarding efficiency.

The execution body of the steps may be, but is not limited to, a node network. The node network is located in devices such as a base station and a terminal.

In an optional embodiment, the operation that the type of the payload contained in the target packet and the start location of the payload are determined includes the following steps.

At S2062, a start location of the target packet is determined based on the type of the target packet.

At S2064, the type of the payload and the start location of the payload are determined based on the start location of the target packet.

In the present embodiment, different types of target packets contain different information, so different processing manners need to be set to process corresponding target packets to improve the accuracy of parsing the packet and ensure that subsequent information can be accurately forwarded to a receiving end.

For example, in a case that the target packet is in the IPv6 format, the start location of the target packet may be determined through the DA or the corresponding Next Header field contained in the target packet; in a case that the target packet is a packet with the Ether type of 0xAB37, then the start location of the target packet is determined through a type value contained in the target packet; in a case that the target packet is an MPLS packet, the start location of the target packet may be determined through a label value contained in the target packet; and in a case that the target packet is other types of packets, the start location of the target packet may be determined in other manners.

In an optional embodiment, the operation that the start location of the target packet is determined based on the type of the target packet includes the following steps.

At S20642, target information, used for determining the start location of the target packet, contained in the target packet is determined based on the type of the target packet.

At S20644, the start location of the target packet is determined based on the target information.

In the present embodiment, the target information includes (but is not limited to) the DA, the Next Header field, the type value, the label value, and the like.

In an optional embodiment, the operation that the start location of the payload is determined based on the start location of the target packet includes the following steps.

At S2042, in a case that the target packet is determined as a first type packet, a packet header of the target packet is skipped to determine the start location of the payload.

At S2044, in a case that the target packet is determined as other types of packets other than the first type packet, a first information value of the target packet is acquired. The first information value is used for indicating a length of first information. The start location of the payload is determined based on the first information value.

In the present embodiment, the first type packet may be a packet in the IPV6 format, or may be other types of packets. The first information may be the BSL information contained in the target packet. Correspondingly, the first information value may be an L value of the BSL information.

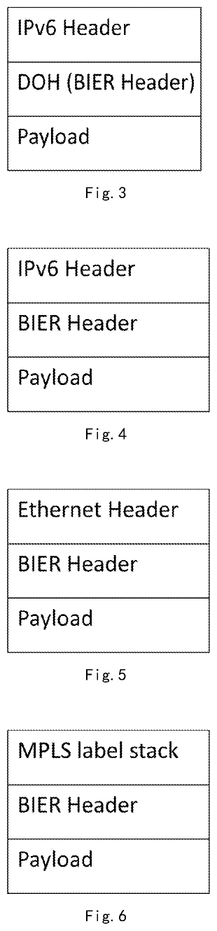

For example, in a case that the target packet is an IPv6 packet, and is encapsulated as shown in FIG. 3, the DA of the target packet is a special reserved address assigned to the BIER. At this moment, a BIER packet may be determined by performing an identification operation on the address.

In a case that the DA is a local interface address and is encapsulated as shown in FIG. 4, a field value of the Next Header field contained in the IPv6 packet is read. In a case that the field value is read to indicating the type of the BIER, the identification operation is performed through the field value to determine the BIER packet, and the starting location of the BIER header is acquired on this basis.

In a case that the target packet is the packet with the Ether type of 0xAB37 and is encapsulated as shown in FIG. 5, then the BIER packet is determined according to the type value contained in the type packet, and the starting location of the BIER header is acquired on this basis.

In a case that the target packet is the MPLS packet and is encapsulated as shown in FIG. 6, a local table entry is matched and searched according to the label value indicated by the front 4 bytes of the target packet, and the BIER packet is determined in a case that the matched table entry indication information is the BIER type. At this moment, the start location of the label is the starting location of the BIER header.

In an optional embodiment, the operation that the first information value of the target packet is acquired includes at least one of the following.

A first offset calculation is performed on the target packet based on the start location of the target packet to obtain first information contained in the target packet; and first matching processing is performed based on the first information to obtain a first information value.

First reading processing is performed on the target packet based on the start location of the target packet to obtain first information; and second matching processing is performed based on the first information to obtain a first information value.

In the present embodiment, the manner of acquiring the first information may be selected according to different requirements for using environments, so as to adapt to a plurality of using cases.

For example, the first offset calculation may be (but is not limited to) offset by 40 bits from the starting location of the BIER header. A BSL value of 4 bits is read, and a corresponding BSL length value L is found according to the value. Similarly, the first reading processing may be (but is not limited to) that, in a case that an encoding manner of a Bit Index Forwarding Table (BIFT)-ID is <BSL, SD, SI> (SD: Sub-Domain; SI: Set Identifier) triple hard encoding, the encoding form may be hard encoding in a manner that the front 4 bits are BSL, the next 8 bits are SD, and the last 8 bits are SI. At this moment, the BSL value may be determined by reading 4 bits from the starting location of the BIER packet, and the corresponding BSL length value is found according to the BSL value L.

In an optional embodiment, the operation that the type of the payload is determined based on the start location of the target packet includes the following steps.

At S20646, in a case that the target packet is determined as the first type packet, a target header field contained in the target packet is determined based on the start location of the target packet, and the type of the payload is determined based on the target header field.

At S20648, in a case that the target packet is determined as other types of packets other than the first type packet, a second offset calculation is performed on the target packet based on the start location of the target packet to obtain an attribute value of the target packet, and the type of the payload is determined based on the attribute value.

In the present embodiment, the target header field may be (but is not limited to) a Next Header field in an extended header of the DOH of the IPv6, or may also be the Next Header field or other fields in the extended header of the BHB, or the Next Header field or other fields in other extended headers such as the extended header of the BHB. The attribute value may be a Proto value of the packet header. Correspondingly, the second offset calculation may be that 74 bits are offset from the starting location of the BIER header, so as to read the Proto value of 6 bits.

In an optional embodiment, after receiving the target packet from the ingress node, the method further includes the following step.

At S2022, in a case that the target packet is determined as a first type packet, a first positioning operation is performed based on an SA contained in the target packet to obtain a first positioning result.

The operation that the payload data is forwarded to a receiving end includes the following step.

At S2082, in a case that a target node is positioned based on the first positioning result, the payload data is transmitted to the target node to indicate the target node to transmit the payload data to the receiving end.

In an optional embodiment,
after receiving the target packet from the ingress node, the method further includes the following step.

At S2024, in a case that the target packet is determined as other types of packets other than the first type packet, the target node is searched according to the type of the payload.

The operation that the payload data is forwarded to a receiving end includes the following step.

At S2084, in a case that it is determined that the target node is searched, a third offset calculation is performed on the payload to obtain target payload data; and the target payload data is transmitted to the target node to indicate the target node to transmit the payload data to the receiving end.

In the present embodiment, in a case of a special service, subsequent data forwarding can only be performed after confirming the type of a service due to the requirements of the special service.

The SA may be the SA in the IPv6 packet, or may also be other types of SA.

For example, in a case that the multicast traffic entering the BIER domain is based on the services such as a Multicast Virtual Private Network (MVPN) or an Ethernet Virtual Private Network (EVPN), since there will be a plurality of MVPN or EVPN instances on edge nodes BFIR and BFER, the packet can only be further forwarded to a receiver by positioning a specific MVPN or EVPN instance when the BFER receives the packet.

Specifically, after an instance server is positioned by using the SA of the IPv6, it is necessary to determine whether a specific service may be positioned. After determining the specific service (for example, a Virtual Private Network 1 (VPN1)), a determined payload packet is forwarded to the receiver in a corresponding VPN; correspondingly, in a case that the payload type is determined as types such as the MPLS or an IPv6 address, the label value of the payload or the IPv6 address are read, and then the corresponding VPN is searched according to the label value of the payload or the IPv6 address; then, the payload content obtained by offsetting the payload packet by 4 bytes (the payload is the MPLS type) or 16 bytes (the payload is the IPv6 address) is forwarded to the receiver in the corresponding VPN. It is to be noted that there is a part of content in the target packet belongs to the content that does not need to be forwarded to the receiver, this part of content needs to be proposed during use.

In an optional embodiment,
before determining the type of the payload contained in the target packet and the start location of the payload, the method further includes the following steps.

At S20402, in a case that the target packet is determined as the first type packet, whether the ingress node is a first ingress node corresponding to a locally stored first ingress node identifier is determined based on the SA contained in the target packet.

At S20404, in a case that the target packet is determined as other types of packets other than the first type packet, second information contained in the target packet is acquired, a fourth offset calculation is performed on the target packet based on the second information and the start location of the target packet to determine a node identifier value of the first ingress node, and whether the ingress node is the first ingress node corresponding to the locally stored first ingress node identifier is determined based on the node identifier value and the second information.

The operation that the type of the payload contained in the target packet and the start location of the payload are determined includes the following step.

At S2046, in a case that the ingress node is determined as the first ingress node corresponding to the locally stored first ingress node identifier, the type of the payload contained in the target packet and the start location of the payload are determined.

In the present embodiment, the second information may be SD information, or may be other information.

In order to improve the reliability of deployment, for the same multicast stream, there may be two or more ingress nodes BFIRs. At this moment, both ingress nodes BFIRs will encapsulate and forward BIER traffic to an egress node BFER. At this moment, the egress node BFER needs to select to receive the traffic of one BFIR and forward the traffic to the receiver, and discard the same multicast traffic forwarded by other BFIRs.

For example, in a case that the target packet is IPv6, the ingress node BFIR is determined through the SA, that is, if SA is an address of the BFIR1, the target packet is processed and forwarded to the receiver.

In an optional embodiment, the method further includes the following step.

At S20406, in a case that the ingress node is determined as another node other than the first ingress node, the target packet is discarded.

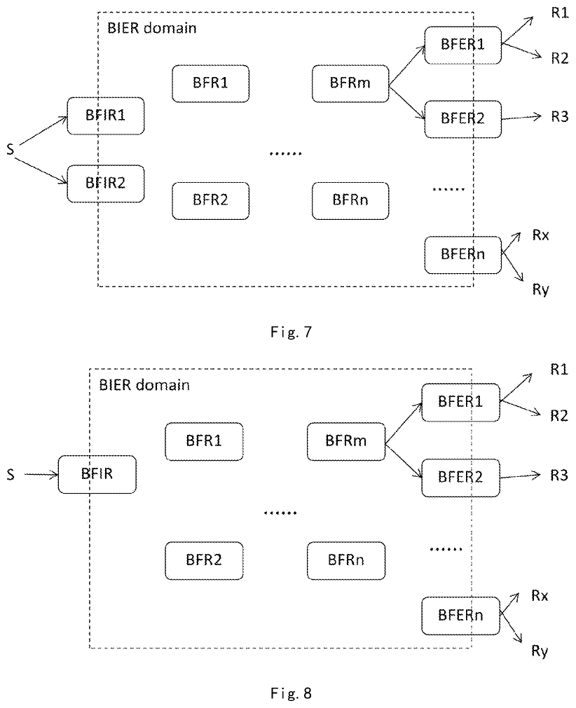

In the present embodiment, the packet transmitted by an unnecessary ingress node BFIR is directly discarded. As shown in FIG. 7, in a normal case, the BFER1/BFER2 only processes the packet from the BFIR1, and discards the packet from the BFIR2; and that is, if the SA is an address of the BFIR2, the packet is directly discarded.

In an optional embodiment, the method further includes the following step.

At S20408, fault detection processing is performed on a target ingress node.

At S204010, in a case that the target ingress node is determined as a fault state, the locally stored first ingress node identifier is updated to a second egress node identifier. The second egress node identifier is used for identifying other ingress nodes other than the first ingress node.

In the present embodiment, when the BFIR1 cannot forward the packet due to a fault, the BFER1/BFER2 is switched to receive and forward the traffic with the SA of a BFIR2 address after learning the fault of the BFIR1 by detecting or other means.

In an optional embodiment, the operation that the second information contained in the target packet is acquired includes at least one of the following.

A fifth offset calculation is performed on the target packet based on the start location of the target packet to obtain second information.

Third matching processing is performed on a local table entry according to a bit index table contained in the target packet to obtain the second information.

In the present embodiment, obtaining the second information in different manners is to adapt to different using backgrounds and using manners, so as to adapt to different using environments.

For example, in a case that the encoding manner of a BIFT-ID is <BSL, SD, SI> triple hard encoding, that is, in a case of performing hard encoding in a manner that the front 4 bits are BSL, the next 8 bits are SD, and the last 8 bits are SI, 4 bits are offset from the beginning of the BIER packet, and the SD value of 8 bits is read. In a case that the BIFT-ID adopts an OSPF/ISIS extended notification manner, a local table entry is queried according to the BIFT-ID to acquire the SD value.

Specifically, after the SD information is acquired, 10 bytes are offset from the starting location of the BIER packet, the BFIR-ID value of the 2 bytes is read, and it is determined to transmit the BFIR information of the packet by using <SD, BFIR-ID>. If the packet is form an unnecessary BFIR, the packet is discarded. As shown in FIG. 7, assuming that the SD is 0, a BFIR-ID of the BFIR1 is 10, and a BFIR-ID of the BFIR2 is 20. The traffic from <SD=0,BFIR-ID=10> is received and is forwarded to the receiver, and the traffic from <SD=0,BFIR-ID=20> is discarded. At this moment, when the BFIR1 cannot forward the packet due to a fault, the BFER1/BFER2 is switched to receive and forward the traffic from the <SD=0,BFIR-ID=20> after learning the fault of the BFIR1 by detecting or other means.

In an optional embodiment, the operation that the first information value of the target packet is acquired includes at least one of the following.

A first information value from an ingress node is received.

A first information value from a controller is received.

A preset first information value is acquired.

In the present embodiment, fixing the BSL value is to reduce a calculation amount involved in a packet parsing process, so as to further simplify an operation on the BFER.

For example, when the BFIR performs notification with the BFER through the BIER Overlay, the BFIR notifies the BFER of the fixed BSL length used by the BFER, that is, the fixed BSL length is used when the BFIR encapsulates the BIER header, for example, 128 bits, 256 bits, or the like. At this moment, the involved BIER Overlay technology includes, but is not limited to, Multicast Listener Discovery (MLD), Protocol Independent Multicast (PIM), MVPN, EVPN, and the like.

Or, in a manner of issuing by the controller, the controller notifies the BFIR to fixedly use a certain fixed BSL to encapsulate the BIER header. The controller notification manner includes, but is not limited to, Border Gateway Protocol-Link State (BGP-LS), Path Computation Element Communication Protocol (PCEP), NETCONF/RESTCONF and a YANG model, and the like.

Or, the BFER is configured with a fixed BSL length, and the BSL length is fully used when the BIER header is parsed.

Similarly, for payload processing, if only one service is deployed, for example, only the IPv4 multicast traffic service is transmitted through the BIER domain, then the payload processing manner may also be fixed through a similar method for fixing the BSL value, the BIER Overlay extension between the BFER and the BFIR and the notification between the BFER and the controller may also adopt a manner similar to fixing the BSL.

In an optional embodiment, after performing a payload parsing operation on the target packet based on the type of the payload and the start location of the payload to obtain the payload data of the payload, the method further includes the following operations.

In a case that it is determined that there is no receiving end for receiving the payload data, at least one of following operations is performed.

A first feedback is transmitted to the ingress node. The first feedback is used for indicating to refuse to receive the packet to be transmitted to receiving end.

A second feedback is transmitted to a controller to indicate the controller to transmit a third feedback to the ingress node. The third feedback is used for indicating to refuse to receive the packet to be transmitted to the receiving end.

In the present embodiment, in a case that there is no receiving end, data redundancy and energy waste caused by transmitting data continuously by the ingress node are indicated to the feedback.

For example, when the BFER performs payload processing, if it is found that there is no corresponding receiver locally, then it indicates that there is a problem in packet transmitting. At this moment, the BFER records the problem, and the BFIR is notified in one of the following manners.

Manner 1:

The BFER notifies through the BIER Overlay technology, and notifies the BFIR not to receive the multicast traffic.

Manner 2:

The BFER notifies the controller in a manner of a Border Gateway Protocol-Link State (BGP-LS), PCEP, NETCONF/RESTCONF and a YANG model, and the like, and the controller notifies the BFIR not to transmit the multicast traffic to the BFER.

After the BFIR learns the information, the multicast traffic is not transmitted to the BFER any longer.

As shown in FIG. 8, assuming that when the BFER2 processes and forwards the BIER packet, it is found that there is no receiver locally for certain multicast traffic. After the BFER2 discards the packet, this problem is recorded, and the BFIR learns the information through the BIER Overlay technology or the controller. When the BFIR encapsulates the multicast traffic subsequently, a BFER2 node will be deleted from a destination Bit-String of the encapsulated BIER header, so that the packet will not be transmitted to the BFER2 any longer.

In an optional embodiment, the method further includes the following step.

At S2010, a fourth feedback is transmitted to the ingress node or the controller. The fourth feedback is used for indicating at least one piece of the following information:
an egress node being a node not supporting a predetermined technology, and a capability level of the egress node supporting the predetermined technology.

In the present embodiment, the fourth feedback is transmitted to the ingress node or the controller, so as to prevent the ingress node or the controller from transmitting traffic information repeatedly.

For example, when the BFER cannot support a complete BIER technology, feedback information is transmitted to the BIER node or the controller, so that the BFIR or the controller determines that the corresponding BFER is in a state in which the complete BIER technology cannot be supported.

When the BFER notifies the controller, it may be reported to the controller or the BFIR through BGP-LS protocol extension. A reporting manner includes (but is not limited to) the following.
Manner 1: an unused bit is selected from Node Flag Bits of a Node Attribute TLV (RFC7752 definition) to represent incomplete BIER technical support.
Manner 2: a type is newly defined in the Node Attribute TLV to represent incomplete BIER technical support.
Manner 3: a sub-TLV is added to BIER Information TLV in Prefix Attribute TLV to represent incomplete BIER technical support. The BIER Information TLV is the definition in draft-ietf-bier-bgp-ls-bier-ext.

Of course, other forms of BGP-LS protocol extension may also be used, which is not limited in the present disclosure.

For example, if the BGP-LS protocol extension is not used, manners such as PCEP node capability extension, or a manner of NETCONF/RESTCONF and a YANG model may also be used.

In an optional embodiment, before transmitting the fourth feedback to the ingress node or the controller, the method further includes the following step.

At S20102, an identifier of a node indicating that the egress node does not support a predetermined technology is added to target protocol information, so as to obtain a fourth feedback.

In the present embodiment, the state of the egress node can be determined quickly by identifying the identifier of the node that does not support the predetermined technology, so as to avoid energy loss and data redundancy.

The step that the identifier of the node indicating that the egress node does not support the predetermined technology is added to the target protocol information may be implemented in the following manners.

For example:
Manner 1: when an MVPN/EVPN service is deployed, it may be implemented by adding a tunnel type as incomplete BIER technology support to a Provider Multicast Service Interface (PMSI) Tunnel Attribute (PTA).
Manner 2: it may be implemented in a manner that the BFER notifies the BFIR node to newly add an extended BIER capability TLV through the protocols such as MLD/PIM/BGP, and the extended BIER capability TLV carries an incomplete BIER technology support capability.
Manner 3: the BFER newly adds the BIER capability extension sub-TLV in the BIER-info TLV/sub-TLV (defined in RFC8401/RFC8444) extended through routing protocols such as OSPF/ISIS of Underlay, or a certain bit of a reserved field in the BIER-info TLV/sub-TLV is directly used to represent the incomplete BIER technology support. The Underlay information will be received by all devices in the whole BIER domain, including BFIR, so the BFIR queries the information notified by the BFER to learn an incomplete BIER technology support condition for the BFER node.
Manner 4: after the BFER reports the capability thereof to the controller, the controller notifies the BFIR in the manner of the BGP-LS, the PCEP, the NETCONF/RESTCONF and a Yang model, and the like, and the notified content is an incomplete support capability sub-TLV, a sub-sub-TLV, or the like.

The BFIR may learn a condition of the BFER that the BIER technology cannot be supported completely in the above manners, and meanwhile, the BFER is not processed specially in a default case. However, refined control may be performed through a policy. Assuming that there is only one BFER needs to be received for certain multicast traffic, and the BFER cannot completely support the BIER technology, then the BFIR may omit an operation of encapsulating the BIER header, and packet can be transmitted to the BFER by directly using IPinIP or other tunnel encapsulation forms.

It is to be noted that the foregoing incomplete BIER technology capability notification may also be further refined to represent different incomplete BIER technology capability support conditions.

For example, the incomplete BIER technology capability may be graded, and different levels represent different BIER technology capabilities. For example, level 1 represents only supporting processing of fixed BSL and fixed payload type, level 2 represents supporting fixed payload processing, but capable of supporting BSL reading processing, and level 3 represents BSL reading and payload type reading processing and the like; or level 1 represents supporting BSL reading processing, level 2 representing supporting BSL and SD reading processing, and level 3 represents supporting BSL, SD, and BFIR-ID reading processing and the like.

A sub-TLV or other extensions may also be added to the extensions such as the BGP-LS/PCEP/YANG model, and specific level information is carried. In this way, the controller or the BFIR node may obtain more accurate condition of the BFER supporting the BIER technology, so as to better adapt to different BIER networking deployment requirements in combination with a policy. For example, the BFIR learns that the BFER node only support the processing of the fixed BSL, and the BFIR will encapsulate the BIER header by only using the BSL, so as to facilitate BFER processing.

Through the description of the above implementations, those skilled in the art can clearly understand that the method of the above embodiments may be implemented by means of software plus a necessary general hardware platform, and of course, may also be implemented through hardware, but in many cases, the former is a better implementation. Based on such an understanding, the technical solutions of the present disclosure essentially or a part thereof that contributes to the related technologies may be embodied in a form of a software product. The computer software product is stored in a storage medium (for example, a Read-Only Memory (ROM)/a Random Access Memory (RAM), a magnetic disk, or an optical disc), and includes several instructions for instructing a terminal device (which may be a mobile phone, a computer, a server, network device, or the like) to perform the methods of various embodiments of the present disclosure.

In the present embodiment, a packet processing apparatus is also provided. The apparatus is configured to implement the above embodiments and preferred implementation manners, and those have not been described and will not be elaborated. As used below, the term “module” may implement a combination of software and/or hardware of a predetermined function. Although the apparatus described in the following embodiments is preferably implemented in software, hardware, or a combination of software and hardware, is also possible and contemplated.

FIG. 9 is a block structural diagram of a packet processing apparatus according to an embodiment of the present disclosure. As shown in FIG. 9, the apparatus includes a receiving module 92, a determination module 94, a parsing module 96, and a transmitting module 98.

The receiving module 92 is configured to receive a target packet from an ingress node.

The determination module 94 is configured to determine a type of a payload contained in the target packet and a start location of the payload.

The parsing module 96 is configured to perform a payload parsing operation on the target packet based on the type of the payload and start location of the payload to obtain payload data of the payload.

The transmitting module 98 is configured to forward the payload data to a receiving end.

In an optional embodiment, the parsing module 96 includes a location determination unit 962, and an information determination unit 964.

The location determination unit 962 is configured to determine a start location of the target packet based on the type of the target packet.

The information determination unit 964 is configured to determine the type of the payload and the start location of the payload based on the start location of the target packet.

In an optional embodiment, the information determination unit 964 includes an information determination sub-unit 9642 and a first location determination sub-unit 9644.

The information determination sub-unit 9642 is configured to determine target information, used for determining the start location of the target packet, contained in the target packet based on the type of the target packet.

The first location determination sub-unit 9644 is configured to determine a start location based on the target information.

In an optional embodiment, the determination module 94 includes a first determination unit 942 and a second determination unit 944.

The first determination unit 942 is configured to: in a case that the target packet is determined as a first type packet, skip a packet header of the target packet to determine the start location of the payload.

The second determination unit 944 is configured to: in a case that the target packet is determined as other types of packets other than the first type packet, acquire a first information value of the target packet, the first information value being used for indicating a length of first information; and determine the start location of the payload based on the first information value.

In an optional embodiment, the second determination unit 844 includes a first calculation sub-unit 9442, and a first reading sub-unit 9444.

The first calculation sub-unit 9442 is configured to perform a first offset calculation on the target packet based on the start location of the target packet to obtain first information contained in the target packet, and perform first matching processing based on the first information to obtain a first information value.

The first reading sub-unit 9444 is configured to perform first reading processing on the target packet based on the start location of the target packet to obtain the first information, and perform second matching processing based on the first information to obtain the first information value.

In an optional embodiment, the information determination unit 964 further includes a first determination sub-unit 9646 and a second determination sub-unit 9648.

The first determination sub-unit 9646 is configured to: in a case that the target packet is determined as the first type packet, determine a target header field contained in the target packet based on the start location of the target packet, and determine the type of the payload based on the target header field.

The second determination sub-unit 9648 is configured to: in a case that the target packet is determined as other types of packets other than the first type packet, perform a second offset calculation on the target packet based on the start location of the target packet to obtain an attribute value of the target packet, and determine the type of the payload based on the attribute value.

In an optional embodiment,
the apparatus further includes a positioning unit 922.

The positioning unit 922 is configured to: after receiving the target packet from an ingress node, in a case that the target packet is determined as a first type packet, perform a first positioning operation based on a source address contained in the target packet to obtain a first positioning result.

The transmitting module 98 includes a first transmitting unit 982.

The first transmitting unit 982 is configured to: in a case that the target node is positioned based on the first positioning result, transmit the payload data to the target node to indicate the target node to transmit the payload data to the receiving end.

In an optional embodiment,
the apparatus further includes a searching unit 924.

The searching unit 924 is configured to: after receiving the target packet from the ingress node, in a case that the target packet is determined as other types of packets other than the first type packet, search the target node according to the type of the payload.

The transmitting module 98 includes a second transmitting unit 984.

The second transmitting unit 984 is configured to: in a case that it is determined that the target node is searched, perform a third offset calculation on the payload to obtain target payload data, and transmit the target payload data to the target node to indicate the target node to transmit the payload data to the receiving end.

In an optional embodiment, the apparatus further includes a first node determination unit 8402 and a second node determination unit 8404.

The first node determination unit 8402 is configured to: before determining the type of the payload contained in the target packet and the start location of the payload, in a case that the target packet is determined as the first type packet, determine whether the ingress node is a first ingress node corresponding to a locally stored first ingress node identifier based on the SA contained in the target packet.

The second node determination unit 8404 is configured to: in a case that the target packet is determined as other types of packets other than the first type packet, acquire second information contained in the target packet, perform a fourth offset calculation on the target packet based on the second information and the start location of the target packet to determine a node identifier value of the first ingress node, and determine whether the ingress node is the first ingress node corresponding to the locally stored first ingress node identifier based on the node identifier value and the second information.

The determination module 94 further includes a determination sub-unit 946.

The determination sub-unit 946 is configured to: in a case that the ingress node is determined as the first ingress node corresponding to the locally stored first ingress node identifier, determine the type of the payload contained in the target packet and the start location of the payload.

In an optional embodiment, the apparatus further includes a packet discarding unit 9406.

The packet discarding unit 9406 is configured to: in a case that the ingress node is determined as another node other than the first ingress node, discard the target packet.

In an optional embodiment, the apparatus further includes a fault detection unit 9408, and a node updating unit 94010.

The fault detection unit 9408 is configured to perform fault detection processing on a target ingress node.

The node updating unit 94010 is configured to: in a case that the target ingress node is determined in a fault state, update the locally stored first ingress node identifier to a second egress node identifier. The second egress node identifier is used for identifying other ingress nodes other than the first ingress node.

In an optional embodiment, the second node determination unit 3404 includes at least one of the following: an offset calculation sub-unit 94042 and a table entry matching sub-unit 94044.

The offset calculation sub-unit 94042 is configured to perform a fifth offset calculation on the target packet based on the start location of the target packet to obtain second information.

The table entry matching sub-unit 94044 is configured to perform third matching processing on a local table entry according to a bit index table contained in the target packet to obtain the second information.

In an optional embodiment, the second determination unit 944 further includes at least one of the following: a first receiving sub-unit 9446, a second receiving sub-unit 9448, and a collection sub-unit 94410.

The first receiving sub-unit 9446 is configured to receive a first information value from an ingress node.

The first receiving sub-unit 9448 is configured to receive a first information value from a controller.

The collection sub-unit 94410 is configured to acquire a preset first information value.

In an optional embodiment, the apparatus further includes an operation execution unit 968.

The operation execution unit 968 is configured to: perform a payload parsing operation on the target packet based on the type of the payload and the start location of the payload to obtain payload data of the payload, and in a case that there is no receiving end for receiving the payload data, execute at least one of the following operations.

A first feedback is transmitted to the ingress node. The first feedback is used for indicating to refuse to receive the packet to be transmitted to receiving end.

A second feedback is transmitted to a controller to indicate the controller to transmit a third feedback to the ingress node. The third feedback is used for indicating to refuse to receive the packet to be transmitted to the receiving end.

In an optional embodiment, the apparatus further includes a feedback module 910.

The feedback module 910 is configured to transmit a fourth feedback to the ingress node or the controller. The fourth feedback is used for indicating at least one piece of the following information:
an egress node being a node that does not support a predetermined technology, and a capability level of the egress node that supports the predetermined technology.

In an optional embodiment, the feedback module 910 further includes an indication unit 9102.

The indication unit 9102 is configured to: before transmitting the fourth feedback to the ingress node or the controller, add an identifier of a node indicating that the egress node does not support a predetermined technology to target protocol information, so as to obtain a fourth feedback.

It is to be noted that each of the various modules may be implemented by software or hardware. For the latter, it may be implemented by, but not limited to, the following manners that the modules are all located in the same processor; or, the modules are located in different processors in any combination form respectively.

The present disclosure will be described below in combination with specific embodiments.

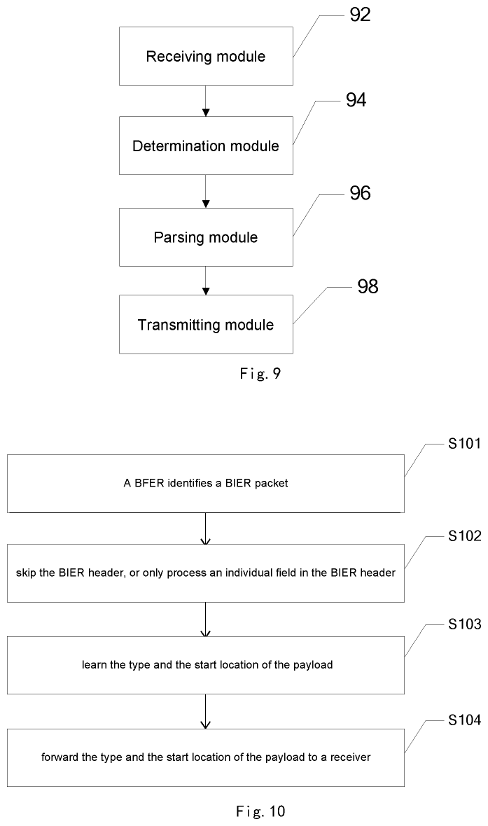

As shown in FIG. 8 and FIG. 10, the packet processing method provided by the embodiments of the present disclosure mainly includes the following steps.

At S101, a BFER receives a packet (corresponding to the foregoing S202).

At S102, after it is identified that the packet is a BIER packet, the processing of a BIER header is skipped, or only a field (including at least one of the following: BSL, BFIR-ID, SD, BIFT-ID) in the BIER header is processed, so as to determine a type of a payload of the BIER packet and a start location (corresponding to the foregoing S204).

At S103, payload packet parsing is performed according to the packet type and the start location of the payload (corresponding to the foregoing S206).

At S104, a parsing result is normally forwarded to a receiver R1/R2/R3 (corresponding to the foregoing S208).

As shown in FIG. 7, when services such as an MVPN or an EVPN are deployed, the BFER acquires required key service instance information. When a dual-root protection function is deployed, the BFER needs to discard repeated traffic according to a specific field.

When the BFER is an incomplete BIER technology supporting capability, the BFER optionally notifies the incomplete BIER technology supporting capability thereof to a controller in a form of a BGP-LS protocol, or a PCEP protocol, or NETCONF, RESTCONF, and the like carrying a YANG model or data; or the BFER optionally notifies the incomplete BIER technology supporting capability thereof to the BFIR node through a BIER Overlay protocol.

The BFIR optionally notifies the BFER of an encapsulated BSL length, or a payload encapsulation manner, or both the encapsulated BSL length or the payload encapsulation manner through the BIER Overlay protocol.

The BIER Overlay technology includes, but is not limited to, MLD, PIM, an MVPN, an EVPN, and the like.

When the BFER does not have a receiver locally for certain multicast traffic, the BFER records the problem, and feeds back the problem to the BFIR through the BIER Overlay, or the BFER notifies the controller. The controller notifies the BFIR, and the BFIR deletes the BFER node when a BIER header of a subsequent packet of the multicast traffic is encapsulated.

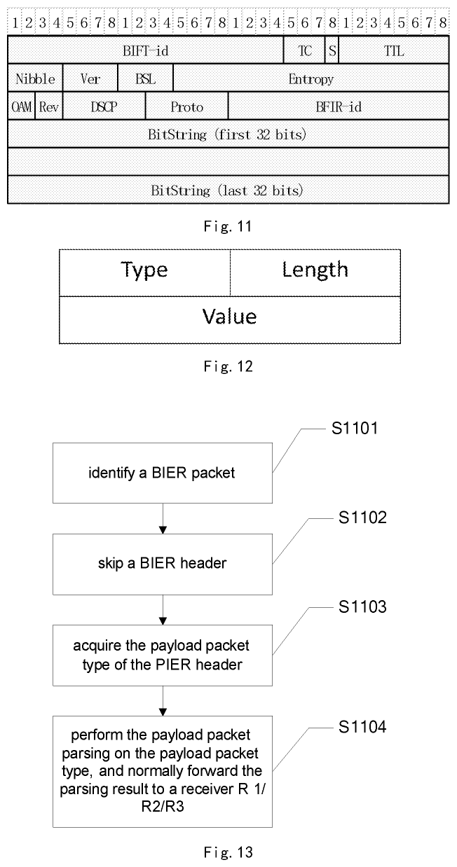

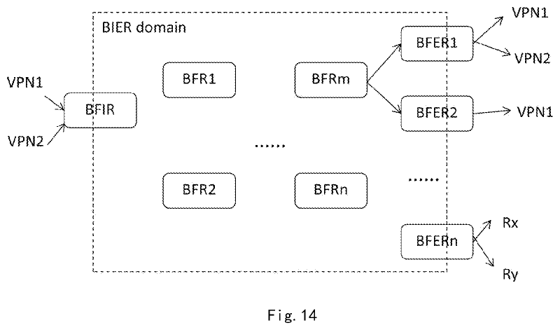

A specific embodiment is shown as follows. It is to be noted that, the BIER header format in the following embodiments is based on the definition in RFC8296, as shown in FIG. 11, the TLV format mentioned below is similar to that shown in FIG. 12.

### Specific Embodiment 1

As shown in FIG. 8, in a case that BFER1 and BFER2 cannot completely support the BIER technology, but still represent as a normal BFER node when the BFER1 and the BFER2 software signaling perform BIER Underlay interaction, that is, when the BFER1 and the BFER2 perform signaling interaction with nodes such as the BFRm through protocols such as OSPF/ISIS, and notification content of the normal BFER node is still adopted, the BFRm will not consider that the BFER1 and the BFER2 are special nodes, will not specially record the BFER1 and the BFER2, and will not perform special operations when a packet is forwarded. Meanwhile, when the BFER1 and the BFER2 perform BIER Overlay interaction with the BFIR, special notification content is also not required. The BFIR will consider the BFER1 and the BFER2 as normal BIER nodes. The BFIR performs normal BIER encapsulation on the multicast traffic and forwards the traffic to the BIER domain. Therefore, the BFER1 and the BFER2 will receive a normal BIER packet. The multicast traffic may be the traffic in the types of IPv4, IPv6, or Ethernet.

As shown in FIG. 13, the packet processing steps of the BFER in the above cases are as follows.

At S1101, a BIER packet is identified.

At S1102, a BIER header is skipped.

At S1103, a payload packet type of the BIER header is acquired.

At S1104, payload packet parsing is performed on the payload packet type, and a parsing result is normally forwarded to a receiver R1/R2/R3.

S1101 specifically includes the following branch steps.

At branch step 1101a, if a received packet is an IPv6 packet and is encapsulated similar to FIG. 3, the DA of the packet is a special reserved address assigned to the BIER, and the BIER packet is identified according to the address.

At branch step 1101b, if a received packet is an IPv6 packet and is encapsulated similar to FIG. 4, the DA of the packet is a local interface address, and a Next Header field of the IPv6 is read; if the field indicates a BIER type, the BIER packet is identified through the field value; and a starting location of the BIER header is acquired on this basis.

At branch step 1101c, if a received packet is the packet with the Ether type of 0xAB37 and is encapsulated similar to FIG. 5, then the BIER packet is identified according to the type value; and the starting location of the BIER header is acquired on this basis.

At branch step 1101d, if a received packet is an MPLS packet and is encapsulated similar to FIG. 6, a local table entry is queried according to a label value of front 4 bytes of the packet, the hit table entry information is a BIER type, and the BIER packet is identified. The start location of the label is the starting location of the BIER header.

S1102 specifically includes the following branch steps.

At branch step 1102a, following the branch step 1101a in S1101, the IPv6 header and a possible extended header, such as DOH, are removed to obtain a payload starting location of the BIER packet.

At branch step 1102b, following the branch step 1101b in S1101, BSL information is acquired first. There are two methods for acquiring the BSL information.

40 bits are offset from the starting location of the BIER header, a BSL value of 4 bits is read, and a corresponding BSL length value L is found according to the value (which is correspondingly defined in RFC8296).

If an encoding manner of a BIFT-ID is <BSL, SD, SI> (SD: Sub-Domain; SI: Set Identifier) triple hard encoding, hard encoding that the front 4 bits are BSL, the next 8 bits are SD, and the last 8 bits are SI may be adopted. The BSL value of the 4 bits is read from the starting location of the BIER packet, and the corresponding BSL length value L is found according to the BSL value.

After the BSL length value L is acquired by the method, the starting location of the payload packet is acquired according to the BSL: that is, (12+L/8) bytes are offset from the BIER header, and the starting location of the payload packet is acquired. For example, the BSL value of the 4 bits is 3, it may be learned that the corresponding BSL value length is 256, and then it may be known through calculating that the starting location of the payload packet may be acquired by offsetting by (12+256/8) 44 bytes from the BIER header.

At branch step 1102c, following the branch step 1101c in S1101, a processing manner is the same as 1102b.

At branch step 1102d, following the branch step 1101d in S1101, there are two processing manners. The first manner is the same as 1102b. The second manner of acquiring the value of the BSL is to querying a local table entry according to a label value in the branch step 1101d to obtain the BSL value; and the starting location of the payload packet is obtained in the same calculation manner of 1102b.

S1103 specifically includes the following branch steps.

At branch step 1103a, following the branch step 1101a in S1101, when the BIER header is encapsulated in a DOH extended header of the IPv6, the packet type of the payload is learned according to the Next Header field in the extended header of the DOH of the IPv6 header. The BIER header may also be encapsulated in other extended headers, such as the HBH, and the SRH, and the processing manners are similar.

At branch step 1103b, following the branch step 1101b in S1101, 74 bits are offset from the starting location of the BIER header, a Proto value of 6 bits is read, and the type of the payload packet is determined according to the value.

At branch step 1103c, following the branch step 1101c in S1101, a processing manner is the same as 1103b.

At branch step 1103d, following the branch step 1101d in S1101, a processing manner is the same as 1103b.

Through the above step, the BFER2/BFER3 may skip complex processing flow of Bit-String and the like in the BIER packet header, and acquire the packet type and the start location of the payload of the BIER, so that payload packet parsing may be performed, and the packet type and the start location are normally forwarded to the receiver R1/R2/R3.

### Specific Embodiment 2

The multicast traffic entering the BIER domain may be based on the services such as an MVPN or an EVPN, since there will be a plurality of MVPN or EVPN instances on edge nodes BFIR and BFER, the packet can only be further forwarded to a receiver by positioning a specific MVPN or EVPN instance when the BFER receives the packet. As shown in FIG. 7, the multicast traffic entering the BIER domain is the MVPN/EVPN traffic, which respectively belongs to VPN1 and VPN2. When the BFER receives the packet, whether the packet should be forwarded to the VPN1 and the VPN2 needs to be distinguished.

It is to be noted that the data plane forwarding technology, that is, the BIER, eliminates the delay of multicast tree establishment because there is no problem of multicast tree establishment. When a link or node problem occurs in a network, the convergence rate is the same as an OSPF or ISIS protocol, which greatly reduces the delay compared with the original multicast tree establishment.

The above case includes the following steps implementation steps.

Step 1201:

At branch step 1201a, following the branch step 1101a in S1101, service instance positioning is performed by using an IPv6 SA to determine that whether a certain VPN, for example, VPN1, may be positioned. Then, through steps 1102a and 1103a, the payload packet is forwarded to the receiver in the corresponding VPN, for example, the VPN1.

At branch step 1201b, after steps 1102b and 1103b, a label value of the payload and an IPv6 address are read according to the payload packet being types of MPLS, IPv6 address, or the like, and a corresponding VPN is searched according to the value; then, the payload content obtained by offsetting the payload packet by 4 bytes (the payload is the MPLS type) or 16 bytes (the payload is the IPv6 address) is forwarded to the receiver in the corresponding VPN. It is to be noted that there is a part of content in the target packet belongs to the content that does not need to be forwarded to the receiver, this part of content needs to be proposed during use.

At branch step 1201c, following the steps 1102c and 1103c, a processing manner is the same as 1201b.

At branch step 1201d, following the steps 1102d and 1103d, a processing manner is the same as 1201b.

Through the above steps, the service application of MVPN/EVPN may be implemented in combination with steps 1102/1103.

### Specific Embodiment 3

In order to improve the reliability of deployment, for the same multicast stream, there may be two or more ingress nodes BFIRs. The deployed BFIRs will encapsulate and forward the BIER traffic to the egress node BFER, the BFER needs to select one of the BFIRs, the traffic from the BFIR is received and forward to the receiver, and the same multicast traffic forwarded by other BFIRs is discarded.

As shown in FIG. 7, the in order to avoid a single-point fault of the BFIR, for the same multicast traffic, both the BFIR1 and the BFIR2 are forwarded to the BFER, the BFER only selects the traffic from the BFIR1 and forwards the traffic to the receiver, and the repeated traffic from the BFIR2 is discarded.

Specific steps in the above process include steps 1301. Step 1301 includes the following branch steps.

At branch step 1301a, following the branch step 1101a in specific step 1101, BFIR is determined by using the IPv6 SA, and the packet transmitted by the unnecessary BFIR is directly discarded. As shown in FIG. 7, in normal cases, the BFER1/BFER2 only processes the packet from the BFER1, and discards the packet from the BFER2. That is, if the SA is an address of the BFER1, then the packet is processed and forwarded to the receiver. If the SA is an address of the BFER2, the packet is directly discarded. When the BFIR1 cannot forward the packet due to a fault, the BFER1/BFER2 switches a traffic receiving direction to receiving and forwarding the traffic with the SA of a BFIR2 address after learning the fault of the BFIR1 by detecting or other means.

At branch step 1301b, following branch step 1101b in S1101, SD information is acquired first, and then 10 bytes is offset from the starting location of the BIER packet according to the acquired SD information, so as to read a BFIR-ID value of 2 bytes. It is determined that the BFIR information of the packet is transmitted according to a packet format of <SD, BFIR-ID>, and the packet is discarded if the packet is from the unnecessary BFIR.

Specifically, as shown in FIG. 7, assuming that SD is 0, the BFIR-ID of the BFIR1 is 10, and the BFIR-ID of the BFIR2 is 20, then the traffic from the <SD=0,BFIR-ID=10> is received and forwarded to the receiver, and the traffic from the <SD=0,BFIR-ID=20> is discarded. When the BFIR1 cannot forward the packet due to a fault, the BFER1/BFER2 is switched to receive and forward the traffic from the <SD=0,BFIR-ID=20> after learning the fault of the BFIR1 by detecting or other means.

Manners for acquiring the SD information may be (but is not limited to) the following two manners.

If an encoding manner of a BIFT-ID is <BSL, SD, SI> triple hard encoding, that is, a manner that the front 4 bits are BSL, the next 8 bits are SD, and the last 8 bits are SI may be adopted, then 4 bits are offset from the beginning of the BIER packet, and the SD value of the 8 bits is read.

If the BIFT-ID adopts an OSPF/ISIS extended notification manner, a local table entry is queried according to the BIFT-ID to acquire the SD value.

At branch step 1301c, following the branch step 1101c in S1101, the SD acquiring method and processing manner are both the same as those in the foregoing branch step 1301b.

At branch step 1301d, following the branch step 1101d in S1101, SD information is acquired by method 2 in the foregoing branch step 1301b, and a processing manner for determining the BFIR information is the same as that in the foregoing branch step 1301b.

Through the above steps, the application of a dual-root protection scenario may be implemented in combination with steps 1102/1103.

### Specific Embodiment 4

In order to further simplify the operation on the BFIR, a fixed BFIR value may be acquired in the following manner without parsing the packet.

Manner 1:

When the BFIR and the BFER notify through the BIER Overlay technology, the BFIR transmits feedback information to the BFER, so as to notify the BSL length that is fixedly used by the BFIR to the BFER, that is, the condition that the BEIR performs BIER header encapsulation by only using a certain fixed BSL length is fed back to the BFER. For example, the BFIR fixedly uses 128 bits, fixedly uses 256 bits, or the like. The involved BIER Overlay technology includes (but is not limited to) MLD, PIM, MVPN, EVPN, and the like.

### Manner 2:

The BSL length that is fixedly used by the BFIR is notified to the BFER in a manner issued by a controller. A specific manner is that: the controller transmits feedback information to the BFER, so as to feed back the condition that the BEIR performs BIER header encapsulation by only using a certain fixed BSL length to the BFER. The manner that the controller transmits feedback includes (but is not limited to) BGP-LS, PCEP, NETCONF/RESTCONF and a YANG model, and the like.

Manner 3:

The fixed BFER length is configured on the BFER, and the BSL length is fully used when the BIER header is parsed.

In the branch steps 1102b, 1102c, and 1102d in S1102, the BSL value does not need to be read from the packet header, the fixed BSL length value determined in the above manner is directly used for calculating to obtain the starting location of the payload of the BIER.

Similarly, for the processing of the payload, if only one service is deployed, for example, only an IPv4 multicast traffic service is transmitted through the BIER domain, then a payload processing manner may also be fixed through a similar method for fixing the BSL value. The BIER Overlay extension between the BFER and the BFIR and message feedback between the BFER and the controller may also adopt a manner similar to the manner of fixing the BSL. Therefore, the payload type does not need to be acquired through packet parsing in S1103.

### Specific Embodiment 5

After S1103, when the BFER performs payload processing, if it is found that there is no corresponding receiver locally, then it indicates that there is a problem in packet transmitting. At this moment, the BFER records the problem, and the BFIR is notified in one of the following manners.

### Manner 1:

The BFER transmits feedback information through the BIER Overlay technology, so as to feed back the condition that the BFER does not receive the multicast traffic to the BFIR.

Manner 2:

The BFER transmits the feedback information to the controller in a manner of the BGP-LS, the PCEP, the NETCONF/RESTCONF and a YANG model. The controller transmits an indication to the BFIR, so that the BFIR indicates not to transmit the multicast traffic to the BFER any longer. After the BFIR learns the indication, the multicast traffic is not transmitted to the BFER any longer.

As shown in FIG. 1, assuming that when the BFER2 processes and forwards the BIER packet, it is found that there is no receiver locally for certain multicast traffic, after the so BFER2 discards the packet, this problem is recorded, and the information is transmitted to the BFIR through the BIER Overlay technology, or the information is transmitted to the BFIR through the controller so that the BFIR learns the information. Therefore, when the BFIR encapsulates the multicast traffic subsequently, a BFER2 node will be deleted from a destination Bit-String of the encapsulated BIER header, so as to achieve an effect of not transmitting the packet to the BFER2 any longer.

### Specific Embodiment 6

When the BFER cannot support a complete BIER technology, it may be notified to the BFIR node or the controller, so that the BFIR or the controller learns the information.

When the BFER notifies the controller, it may be reported to the controller or the BFIR through BGP-LS protocol extension. An optional manner is as follows.

An unused bit is selected from Node Flag Bits of a Node Attribute TLV (RFC7752 definition) to represent incomplete BIER technology support. The TLV format is as shown in FIG. 13.

A type is newly defined in the Node Attribute TLV to represent incomplete BIER technology support.

A sub-TLV is added to BIER Information TLV in Prefix Attribute TLV to represent incomplete BIER technology support. The BIER Information TLV is defined in draft-ietf-bier-bgp-ls-bier-ext.

Of course, other forms of BGP-LS protocol extension may also be used, which is not specifically limited in the present embodiment.

Similarly, if the BGP-LS protocol extension is not used, manners such as PCEP node capability extension, or a manner of NETCONF/RESTCONF and a YANG model may also be used.

In this way, the controller may learn the condition of the BFER supporting the BIER technology, and then the BFER cannot be planned as the BFIR, so as to avoid a problem caused by the lack of the BIER forwarding capability.

The BFER may notify the condition that the BFER is incomplete BIER technology support to the BFIR node through the BIER Overlay/Underlay technology extension, or may notify that the BFER is incomplete BIER technology support to the BFIR node through the controller. A specific optional notification manner is as follows.

Manner 1:

When an MVPN/EVPN service is deployed, it may be implemented by adding a tunnel type as incomplete BIER technology support to a PTA.

Manner 2:

It may be implemented in a manner that the BFER notifies the BFIR node to newly add an extended BIER capability TLV through the protocols such as MLD/PIM/BGP, and the extended BIER capability TLV carries an incomplete BIER technology support capability.

Manner 3:

The BFER newly adds the BIER capability extension sub-TLV in the BIER-info TLV/sub-TLV (defined in RFC8401/RFC8444) extended through routing protocols such as OSPF/ISIS of Underlay, or a certain bit of a reserved field in the BIER-info TLV/sub-TLV is directly used to represent the incomplete BIER technology support. The Underlay information will be received by all devices in the whole BIER domain, including BFIR, so the BFIR queries the information notified by the BFER to learn an incomplete BIER technology support condition of the BFER node.

After the BFER reports the capability thereof to the controller, the controller notifies the capability to the BFIR in the manner of the BGP-LS, the PCEP, the NETCONF/RESTCONF and a Yang model, and the like, and the notified content is an incomplete support capability sub-TLV, a sub-sub-TLV, or the like.

Manner 4:

Therefore, the BFIR may learn a condition that the BFER cannot completely support the BIER technology, and the BFER is not processed specially in a default case. However, refined control may be performed through a policy. Assuming that there is only one BFER needs to be received for certain multicast traffic, and the BFER cannot completely support the BIER technology, then the BFIR may omit an operation of encapsulating the BIER header, and the packet can be transmitted to the BFER by directly using IPinIP or other tunnel encapsulation forms.

The above incomplete BIER technology capability notification may also be further refined to represent different incomplete BIER technology capability support conditions.

Manner 1:

The incomplete BIER technology capability may be graded, and different levels represent different BIER technology capabilities. For example, level 1 represents only supporting processing of fixed BSL and fixed payload type, level 2 represents supporting fixed payload processing, but capable of supporting BSL reading processing, and level 3 represents BSL reading and payload type reading processing and the like; or level 1 represents supporting BSL reading processing, level 2 representing supporting BSL and SD reading processing, and level 3 represents supporting BSL, SD, and BFIR-ID reading processing and the like.

Manner 2:

A sub-TLV or other extensions may also be added to the extensions such as the BGP-LS/PCEP/YANG model, specific level information is carried. In this way, the controller or the BFIR node may obtain more accurate condition of the BFER supporting the BIER technology, so as to better adapt to different BIER networking deployment requirements in combination with a policy. For example, the BFIR learns that the BFER node only support the processing of the fixed BSL, and the BFIR will encapsulate the BIER header by only using the BSL, so as to facilitate BFER processing.

The embodiments of the present disclosure further provide a computer-readable storage medium. The computer-readable storage medium stores a computer program. The computer program is configured to perform the steps in any one of the abovementioned embodiments when running.

In an exemplary embodiment, the above computer-readable storage medium may include, but is not limited to, various media capable of storing a computer program, such as a USB flash disk, a Read-Only Memory (ROM), a Random Access Memory (RAM), a mobile hard disk, a magnetic disk, or a compact disk.

The embodiments of the present disclosure further provide an electronic apparatus, including a memory and a processor. The memory stores a computer program. The processor is configured to run the computer program to perform the steps in any one of the method embodiments.

In an exemplary embodiment, the electronic apparatus may further include a transmission device and an input/output device. The transmission device is connected to the processor. The input/output device is connected to the processor.

A specific example in the present embodiment may refer to the examples described in the above embodiments and exemplary implementations, which will not be elaborated herein in the present embodiment.

Apparently, those skilled in the art shall understand that the various modules or various steps in the present disclosure may be implemented by using a general computing apparatus. They may be centralized on a single computing apparatus or may be distributed on a network composed of a plurality of computing apparatuses. They may be implemented by using executable program codes of the computing apparatuses. Thus, they may be stored in a storage apparatus and executed by the computing apparatuses, the shown or described steps may be executed in a sequence different from this sequence under certain conditions, or they are manufactured into various integrated circuit modules respectively, or a plurality of modules or steps therein are manufactured into a single integrated circuit module. Therefore, the present disclosure is not limited to any specific hardware and software combination.

The foregoing descriptions are merely preferred embodiments of the present disclosure, but are not intended to limit the present disclosure. Persons skilled in the art understand that the present disclosure may have various modifications and variations. Any modification, equivalent replacement, improvement or the like made within the principle of the present disclosure shall fall within the protection scope of the present disclosure.

1. A packet processing method, comprising:
receiving a target packet from an ingress node;
determining a type of a payload contained in the target packet and a start location of the payload;
performing a payload parsing operation on the target packet based on the type of the payload and the start location of the payload to obtain payload data of the payload; and
forwarding the payload data to a receiving end.

2. The method according to claim 1, wherein the determining a type of a payload contained in the target packet and a start location of the payload comprises:
determining a start location of the target packet based on the type of the target packet; and
determining the type of the payload and the start location of the payload based on the start location of the target packet.

3. The method according to claim 2, wherein the determining the start location of the payload based on the start location comprises:
in a case that the target packet is determined as a first type packet, skipping a packet header of the target packet to determine the start location of the payload;
in a case that the target packet is determined as other types of packets other than the first type packet, acquiring a first information value of the target packet, the first information value being used for indicating a length of first information; and determining the start location of the payload based on the first information value.

4. The method according to claim 2, wherein the determining the start location of the payload based on the start location of the target packet comprises:
in a case that the target packet is determined as a first type packet, determining a target header field contained in the target packet based on the start location of the target packet, and determining the type of the payload based on the target header field; and
in a case that the target packet is determined as other types of packets other than the first type packet, performing a second offset calculation on the target packet based on the start location of the target packet to obtain an attribute value of the target packet, and determining the type of the payload based on the attribute value.

5. The method according to claim 1, wherein
after the receiving a target packet from an ingress node, further comprising: in a case of determining the target packet as a first type packet, performing a first positioning operation based on a Source Address (SA) contained in the target packet to obtain a first positioning result; and the forwarding the payload data to a receiving end comprises: in a case that a target node is positioned based on the first positioning result, transmitting the payload data to the target node to indicate the target node to transmit the payload data to the receiving end;
or,
after the receiving a target packet from an ingress node, further comprising: in a case that the target packet is determined as other types of packets other than the first type packet, searching the target node according to the type of the payload; and the forwarding the payload data to a receiving end comprises: in a case that the target node is searched, performing a third offset operation on the payload to obtain target payload data, and transmitting the target payload data to the target node to indicate the target node to transmit the payload data to the receiving end.

6. The method according to claim 1, before the determining a type of a payload contained in the target packet and a start location of the payload, further comprising:
in a case that the target packet is determined as the first type packet, determining whether the ingress node is a first ingress node corresponding to a locally stored first ingress node identifier based on an SA contained in the target packet;
in a case that the target packet is determined as other types of packets other than the first type packet, acquiring second information contained in the target packet, performing a fourth offset calculation on the target packet based on the second information and the start location of the target packet to determine a node identifier value of the first ingress node, and determining whether the ingress node is the first ingress node corresponding to the locally stored first ingress node identifier based on the node identifier value and the second information; and
the determining a type of a payload contained in the target packet and a start location of the payload comprises: in a case that the ingress node is determined as the first ingress node corresponding to the locally stored first ingress node identifier, determining the type of the payload contained in the target packet and the start location of the payload.

7. The method according to claim 3, wherein the acquiring a first information value of the target packet comprises at least one of the following:
receiving the first information value from the ingress node;
receiving the first information value from a controller; or
acquiring a preset first information value.

8. The method according to claim 1, after the performing a payload parsing operation on the target packet based on the type of the payload and the start location of the payload to obtain payload data of the payload, further comprising:
in a case that it is determined that there is no receiving end for receiving the payload data, performing at least one of the following operations:
transmitting a first feedback to the ingress node, the first feedback being used for indicating to refuse to receive the packet to be transmitted to the receiving end; and
transmitting a second feedback to a controller to indicate the controller to transmit a third feedback to the ingress node, the third feedback being used for indicating to refuse to receive the packet to be transmitted to the receiving end.

9. The method of claim 1, further comprising:
transmitting a fourth feedback to the ingress node or the controller, the fourth feedback being used for indicating at least one piece of the following information: an egress node being a node that does not support a predetermined technology, and a capability level of the egress node that supporting the predetermined technology.

10. A packet processing apparatus, comprising:
a receiving module, configured to receive a target packet from an ingress node;
a determination module, configured to determine a type of a payload contained in the target packet and a start location of the payload;
a parsing module, configured to perform a payload parsing operation on the target packet based on the type of the payload and the start location of the payload to obtain payload data of the payload; and
a transmitting module, configured to forward the payload data to a receiving end.

11. A non-transitory computer-readable storage medium, wherein the computer-readable storage medium stores a computer program; and the computer program is configured to, when executed by a processor, implement the steps in the method as claimed in claim 1.

12. An electronic apparatus, comprising a memory and a processor, wherein the memory stores a computer program, and the processor is configured to run the computer program to implement the method as claimed in claim 1.

13. An electronic apparatus, comprising a memory and a processor, wherein the memory stores a computer program, and the processor is configured to run the computer program to implement the method as claimed in claim 2.

14. An electronic apparatus, comprising a memory and a processor, wherein the memory stores a computer program, and the processor is configured to run the computer program to implement the method as claimed in claim 3.

15. An electronic apparatus, comprising a memory and a processor, wherein the memory stores a computer program, and the processor is configured to run the computer program to implement the method as claimed in claim 4.

16. An electronic apparatus, comprising a memory and a processor, wherein the memory stores a computer program, and the processor is configured to run the computer program to implement the method as claimed in claim 5.

17. An electronic apparatus, comprising a memory and a processor, wherein the memory stores a computer program, and the processor is configured to run the computer program to implement the method as claimed in claim 6.

18. An electronic apparatus, comprising a memory and a processor, wherein the memory stores a computer program, and the processor is configured to run the computer program to implement the method as claimed in claim 7.

19. An electronic apparatus, comprising a memory and a processor, wherein the memory stores a computer program, and the processor is configured to run the computer program to implement the method as claimed in claim 8.

20. An electronic apparatus, comprising a memory and a processor, wherein the memory stores a computer program, and the processor is configured to run the computer program to implement the method as claimed in claim 9.
